(19) United States
(12) Patent Application Publication
(10) Pub. No.: US 2018/0119811 A1
(43) Pub. Date: May 3, 2018

(54) Ball Variator Continuously Variable Transmission

(71) Applicant: Dana Limited, Maumee, OH (US)

(72) Inventor: Sebastian J. Peters, Cedar Park, TX (US)

(21) Appl. No.: 15/857,865

(22) Filed: Dec. 29, 2017

Related U.S. Application Data
(60) Provisional application No. 62/591,231, filed on Nov. 28, 2017.

(51) Int. Cl. F16H 61/664; F16H 63/06; F16H 63/42; F16H 59/40; F16H 37/08; F16H 15/50

(52) U.S. Cl. CPC F16H 61/6645; F16H 63/067; F16H 63/42; F16H 2059/704; F16H 37/084; F16H 15/506; F16H 2037/0866; F16H 59/40

(57) ABSTRACT

Devices and methods are provided herein for the transmission of power in motor vehicles. Power is transmitted in a smoother and more efficient manner by splitting torque into two or more torque paths. Provided herein is variator including a rotatable shaft operably coupleable to a source of rotational power and a variator assembly having a first traction ring assembly and a second traction ring assembly in contact with a plurality of balls, wherein each ball of the plurality of balls has a tiltable axis of rotation. The variator assembly is coaxial with the rotatable shaft and further includes a first axial thrust bearing coupled to the rotatable shaft and the first traction ring assembly and a second axial thrust bearing coupled to the rotatable shaft and the second traction ring assembly.

### RELATED APPLICATION

This application claims the benefit of U.S. Provisional Patent Application No. 62/591,231, filed Nov. 28, 2017, which is incorporated herein by reference in its entirety.

### BACKGROUND

A driveline including a continuously variable transmission allows an operator or a control system to vary a drive ratio in a stepless manner, permitting a power source to operate at its most advantageous rotational speed.

### SUMMARY

Provided herein is a variator including a rotatable shaft operably coupleable to a source of rotational power and a variator assembly having a first traction ring assembly and a second traction ring assembly in contact with a plurality of balls, wherein each ball of the plurality of balls has a tiltable axis of rotation. The variator assembly is coaxial with the rotatable shaft and further includes a first axial thrust bearing coupled to the rotatable shaft and the first traction ring assembly and a second axial thrust bearing coupled to the rotatable shaft and the second traction ring assembly.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the preferred embodiments are set forth with particularity in the appended claims. A better understanding of the features and advantages of the present embodiments will be obtained by reference to the following detailed description that sets forth illustrative embodiments, in which the principles of the preferred embodiments are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a schematic illustration of a variator having two axial thrust bearings coupled to a main shaft.

### DETAILED DESCRIPTION OF THE PREFERRED EMBODIMENTS

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments. Furthermore, the preferred embodiments includes several novel features, no single one of which is solely responsible for its desirable attributes or which is essential to practicing the embodiments described.

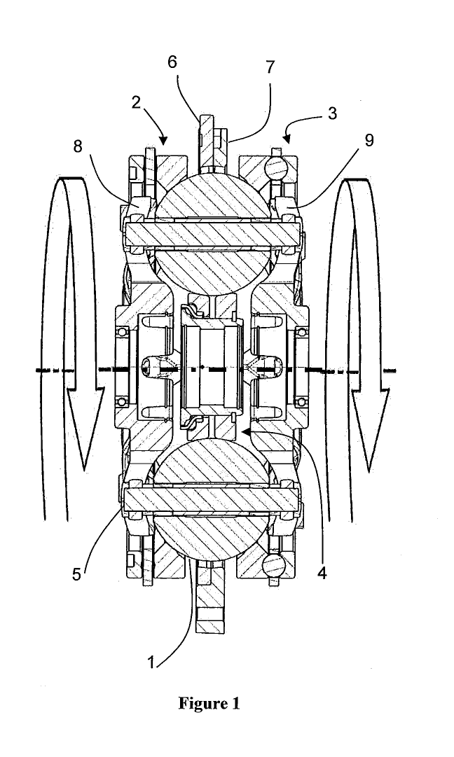

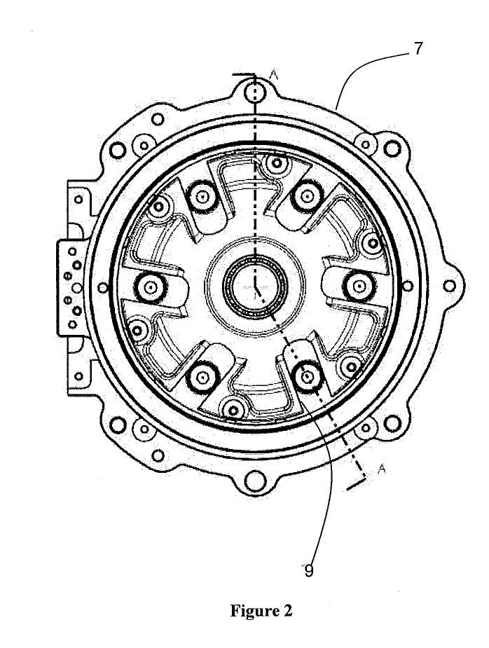

Provided herein are configurations of CVTs based on a ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface in contact with the balls, an input traction ring 2, an output traction ring 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, but are slightly different.

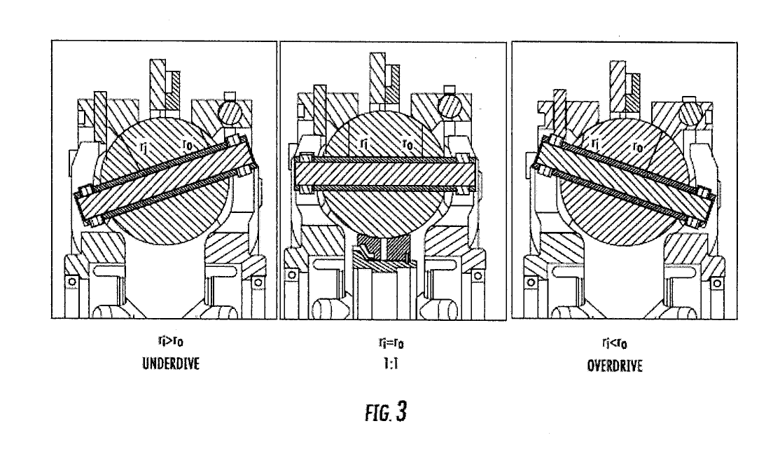

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments disclosed here are related to the control of a variator and/or a CVT using generally spherical planets each having a tiltable axis of rotation that are adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

As used here, the terms “operationally connected,” “operationally coupled”, “operationally linked”, “operably connected”, “operably coupled”, “operably linked,” “operably coupleable” and like terms, refer to a relationship (mechanical, linkage, coupling, etc.) between elements whereby operation of one element results in a corresponding, following, or simultaneous operation or actuation of a second element. It is noted that in using said terms to describe the embodiments, specific structures or mechanisms that link or couple the elements are typically described. However, unless otherwise specifically stated, when one of said terms is used, the term indicates that the actual linkage or coupling take a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these are typically understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here operate in both tractive and frictional applications. For example, in the embodiment where a CVT is used for a bicycle application, the CVT operates at times as a friction drive and at other times as a traction drive, depending on the torque and speed conditions present during operation.

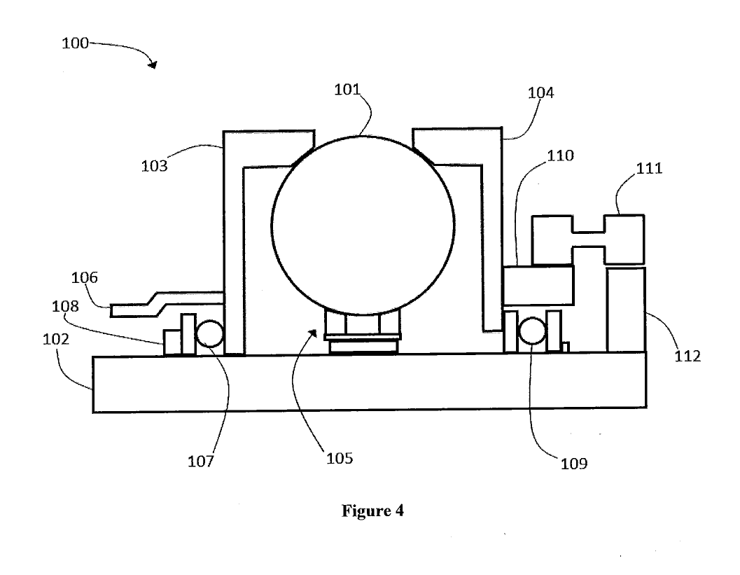

Referring now to FIG. 4, in some embodiments, a variator 100 is similar to the variator depicted in FIGS. 1-3. For description purposes, only the differences between the variator 100 and the variator of FIGS. 1-3 will be described. The variator 100 includes a number of balls 101 arrayed radially about a rotatable main shaft 102. Each ball 101 is in contact with a first traction ring assembly 103 and a second traction ring assembly 104. The variator 100 includes an idler assembly 105 located radially inward of the first traction ring assembly 103 and the second traction ring assembly 104. In some embodiments, a drive gear 106 is coupled to the first traction ring 103. The drive gear 106 is optionally adapted to be a sun gear from an input planetary gear set (not shown). In some embodiments, gear 106 is a driven gear. Several illustrative examples of input planetary gear set couplings to the variator 100 are depicted in U.S. patent application Ser. No. 15/474,120, which is hereby incorporated by reference. The variator 100 includes a first axial thrust bearing 107 operably coupled to the first traction ring assembly 103. The first axial thrust bearing 107 is coupled to a pre-load nut 108. The pre-load nut 108 is secured through threads or similar means to the main shaft 102. The variator 100 includes a second axial thrust bearing 109 operably coupled to the second traction ring assembly 104. The second axial thrust bearing 109 is axially fixed to the main shaft 102 with a c-clip or other fastening means. In some embodiments, the second traction ring assembly 104 is coupled to an output driver 110. In some embodiments, the output gear 110 is a drive gear. The output driver 110 couples to a transfer gear 111. The transfer gear 111 operably couples to the main shaft 102 through a coupling 112.

In some embodiments, during operation of the variator 100, a rotational power is optionally transmitted to the first traction ring assembly 103 through the main shaft 102 and the drive gear 106. Power is transmitted out of the variator 100 through the second traction ring assembly 104 and the output driver 110.

In some embodiments, during operation of the variator 100, a rotational power is optionally transmitted to the second traction ring assembly 104 through the main shaft 102 and the gear 110. Power is transmitted out of the variator 100 through the first traction ring assembly 103 and the gear 106.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein may be employed in practice. It is intended that the following claims define the scope of the preferred embodiments and that methods and structures within the scope of these claims and their equivalents be covered thereby.

What is claimed is:

1. A variator comprising:
a rotatable shaft operably coupleable to a source of rotational power;
a variator assembly having a first traction ring assembly and a second traction ring assembly in contact with a plurality of balls, wherein each ball of the plurality of balls has a tiltable axis of rotation, the variator assembly is coaxial with the rotatable shaft;
a first axial thrust bearing coupled to the rotatable shaft and the first traction ring assembly; and
a second axial thrust bearing coupled to the rotatable shaft and the second traction ring assembly.

2. The variator of claim 1, further comprising an idler assembly coupled to each ball and positioned radially inward of the first traction ring assembly and the second traction ring assembly.

3. The variator of claim 1, wherein the first traction ring assembly is configured to receive a rotational power.

4. The variator of claim 1, wherein the first traction ring assembly is configured to transmit a rotational power out of the variator.

5. The variator of claim 1, wherein the second traction ring assembly is configured to receive a rotational power.

6. The variator of claim 1, wherein the second traction ring assembly is configured to transmit a rotational power out of the variator.

7. The variator of claim 7, wherein the second traction ring assembly is operably coupled to a transfer gear and wherein the transfer gear is coupled to the rotatable shaft.
